(19) United States
(12) Patent Application Publication
(10) Pub. No.: US 2025/0064070 A1
(43) Pub. Date: Feb. 27, 2025

(54) FOOD PROCESSING APPARATUS AND CORRESPONDING FOOD PROCESSING METHOD

(71) Applicant: Provisur Technologies, Inc., Chicago, IL (US)

(72) Inventor: Heinz Burkhalter, Wil (CH)

(73) Assignee: Provisur Technologies, Inc., Chicago, IL (US)

(21) Appl. No.: 18/944,301

(22) Filed: Nov. 12, 2024

Related U.S. Application Data
(63) Continuation of application No. 17/442,802, filed on Sep. 24, 2021.

(30) Foreign Application Priority Data
Apr. 18, 2019 (DE) 102019110313.4

(51) Int. Cl. A22C 17/00; A22C 7/00; B30B 15/26; B30B 15/34

(52) U.S. Cl. CPC A22C 17/002; A22C 7/003; A22C 17/0073; A22C 17/0093; B30B 15/26; B30B 15/34

(57) ABSTRACT

A food processing apparatus for processing food products includes a press, a control unit and an first analyzing device. The press presses the food products with specific pressing parameters. The control unit is connected to an output side of the press and sets the pressing parameters. The first analyzing device scans the food products before pressing and generates corresponding first analysis parameters of the food products which reflect product properties of the examined food product. The control unit is connected on an input side of the first analyzing device and records the first analysis parameters and sets the pressing parameters as a function of the first analysis parameters.

This application is a continuation application of U.S. application Ser. No. 17/442,802 filed on Sep. 24, 2021, which is a 35 U.S.C. 371 application of PCT/EP2020/060159 filed on Apr. 9, 2020, the contents of which are incorporated herein by reference.

The invention concerns a food processing apparatus and a corresponding food processing method for processing food products, such as meat products.

In industrial meat production, pieces of meat from a cutting plant are cut into portions and then packaged. Furthermore, it is known from the state of the art that the pieces of meat are pressed before cutting, which significantly enhances the subsequent cutting and packaging. For example, pressing the usually irregularly shaped pieces of meat from the cutting plant results in a regular product shape, which can be block-shaped, for example. This considerably reduces cutting losses due to cuts and end cuts during the subsequent slicing process. Pressing the pieces of meat before slicing thus increases the product yield during slicing. In addition, cutting portions to a pre-defined weight, creating a desired portion size and presenting them in the package is improved by pressing.

A problem with this well-known pressing is the fact that the pieces of meat from the cutting plant vary greatly in shape, size, weight and composition (flesh, fat, bone, gristle). The range of variation of the pieces of meat arriving from the cutting plant must therefore be taken into account when pressing the pieces of meat. The so-called dynamic pressing is known from the state of the art. The pieces of meat are pressed in a pressing chamber in three pressing axes, whereby the pressing process can be adjusted with regard to the pressing force, the pressing speed, the pressing travel and the pressing travel profile (pressing travel-time characteristic) in order to achieve an optimum pressing result. During pressing in particular, the longitudinal and vertical axes communicate via the meat product in terms of pressure. The vertical axis adapts its pressing travel profile to the pressure and expansion of the meat product. Usually, certain pressing parameters for a product category (e.g. raw ham) are optimized and then maintained during the subsequent pressing of the products of this product category.

However, the problem with this well-known dynamic press is the fact that meat products in the same product category also have a considerable variation in shape, size, weight and composition (flesh, fat, bone, gristle), whereas meat products in the same product category are pressed with constant pressing parameters. If, for example, a meat product is particularly large, pressing with the specified pressing parameters can lead to the breaking of bones in the meat product, which is undesirable.

Finally, reference is made to U.S. Pat. No. 8,166,856 B2 and DE 102 20 006 A1 regarding the technological background of the invention.

The invention is therefore based on the task of achieving better results when pressing food products (e.g. meat products) in industrial food production.

This task is solved by a food processing apparatus in accordance with the invention or by a food processing method in accordance with the invention in accordance with the independent claims.

The food processing apparatus according to the invention initially has a press in accordance with the state of the art to press food products with certain pressing parameters (e.g. pressing force, pressing travel, pressing travel profiles).

In addition, the food processing apparatus according to the invention has a control unit which is connected to the press on the output side and sets the pressing parameters of the press so that the pressing process is carried out in accordance with the specified pressing parameters.

The food processing apparatus according to the invention is characterized by a first analyzing device (e.g. scanner), which analyzes the food product before pressing and generates corresponding first analysis parameters, whereby the first analysis parameters reflect product properties of the analyzed food product.

The control unit is connected on the input side with the first analyzing device and receives the first analysis parameters, while the control unit sets the pressing parameters depending on the first analysis parameters.

In a preferred embodiment of the invention, the control unit can set the maximum pressing force with which the respective food product is pressed as the pressing parameter. The maximum pressing force can be set in a single pressing axis. Preferably, however, the maximum pressing force is specified in three pressing axes which are aligned transversely to each other, in particular at right angles to each other. However, it is also possible within the scope of the invention that the press has a rotary mechanism so that the various pressing axes are not perpendicular to each other.

Furthermore, within the scope of the invention, it is possible for the control unit to set the pressing travel in at least one pressing axis as a pressing parameter. The term “pressing travel” or “forming travel” does not refer to the pressing travel of press jaws. Rather, the term pressing travel in the context of the invention refers to the pressing travel performed by the pressed food product itself. Here, too, the pressing travel can be specified in a single pressing axis. Preferably, however, the pressing travel is specified in three pressing axes which are aligned transversely to each other, in particular at right angles to each other.

The invention also offers the possibility of setting the pressing time as the pressing parameter, i.e. the duration of a pressing process. For example, with a low degree of forming, the pressing time may be very short, i.e. the pressing process takes place very quickly, which enables a high product throughput. With a high degree of forming, on the other hand, it may be necessary to press relatively slowly, i.e. with a long pressing time. This reduces the product throughput, but prevents the food product from being damaged, e.g. by breaking the product or breaking a bone in the food product.

Furthermore, the invention also offers the possibility of massaging the food products during pressing. It is also possible to press in stages.

In addition, the invention also offers the possibility of specifying a pressing force-time curve as a pressing parameter, which shows the course of the pressing force as a function of the pressing time in at least one pressing axis. Here, too, it is possible that the pressing force-time curve is only specified in a single pressing axis. Preferably, however, the pressing force-time curve is specified in three pressing axes which are aligned transversely to each other, in particular at right angles to each other.

For example, the press result can also be improved by setting a comprehensive behavior model of the pressing axes and not a fixed profile, e.g. that the height gives way to a certain behavior when pressing with the length. Furthermore, certain food products are massaged with force. This allows considerable improvements to be achieved in the shaping of the product.

In addition, it is also possible for the control unit to set a pressing travel-time curve as a pressing parameter, which shows the course of the pressing travel in relation to the pressing time in at least one pressing axis. Here, too, it is preferably intended that the pressing travel-time curve is specified in three pressing axes which are aligned transversely to each other, in particular at right angles to each other.

In a preferred embodiment of the invention, the control unit determines an actual shape of the food products from the first analysis parameters before pressing. In addition, the control unit receives a desired target shape of the food products as input information, whereby the desired target shape can be specified, for example, by a downstream slicing device or by a downstream packaging device. The control unit then preferably determines from the specified target shape and from the determined actual shape of the respective food product the degree of deformation required to press the food product from the actual shape into the desired target shape. It has already been briefly mentioned above that with a high degree of deformation there is a risk that the food product will be damaged, for example by a bone fracture in the food product. The control unit can prevent such damage to the food product by adjusting the pressing parameters depending on the degree of deformation required. For example, the pressing time can be extended and the pressing speed reduced if a high degree of deformation is required, as the risk of damage to the pressed food product is lower with slow pressing.

In the preferred embodiment of the invention, the pressed products are analyzed not only before pressing, but also after pressing. For this purpose, a second analyzing device (e.g. scanner) is preferably provided, which analyzes the food products after pressing and generates corresponding second analysis parameters, which reproduce the product characteristics of the pressed food product. The control unit then sets the pressing parameter preferably not only depending on the analysis before pressing, but also depending on the analysis after pressing.

In the post-press analysis, the control unit can also detect whether the pressed food product has broken during the pressing process by analyzing the second analysis parameters, for example with a complete splitting of the food product or with a bone fracture in the food product. If such a fracture is detected, the control unit will preferably adjust the pressing parameters so that food products of the same product type are not subsequently fractured.

The first or second analyzing device is preferably a scanner, in particular an optical scanner or an X-ray scanner, which scans the food products and determines at least one of the following product characteristics:
Length of the food product,
Width of the food product,
Height of the food product,
Volume of the food product,
Form of the food product,
Fat content of the food product,
Bone content of the food product,
Lean meat content of the food product and/or
Bone volume of the food product,
Bone form of the food product,
Presence of a brow of the food product.

Such scanners are known from the state of the art and therefore do not need to be described in detail.

In addition, the first or second analyzing device may have a temperature measuring device which measures the temperature of the food products as a product characteristic. For example, this temperature measurement can be carried out using a thermal imaging camera.

Furthermore, the first or second analyzing device or the control unit can carry out a force-displacement measurement to determine the product strength, whereby the modulus of elasticity or the hardness of the food product is measured. For example, the freezing point of meat can vary considerably due to the different salt content of the meat product. However, the freezing point is the decisive factor during pressing, as the forming process is only maintained in this temperature range or below.

Further, the pressing parameters can be fed back from the press to the control unit, which then derives other product parameters from the pressing parameters. For example, the percentage of the frozen part of the product, the percentage of the unfrozen part of the product or the viscosity of the product can be derived from the measured pressing parameters.

For the sake of completeness, it should be mentioned that the food processing apparatus according to the invention preferably also has a slicing device to cut the pressed food products after pressing. Such slicing devices are known from the state of the art and are also referred to as “slicers”.

In addition, the food processing apparatus according to the invention may also include a packaging device for packaging the pressed and sliced food products. For example, the food products can be placed in trays. For example, the packaging device can be a so-called thermoformer, as it is known from the state of the art.

Furthermore, the food processing apparatus according to the invention preferably also includes a conveyor (e.g. conveyor belt) to convey the food products along a conveyor path. Preferably, the conveyor path conveys the food products successively through the first analyzing device, through the press, through the second analyzing device, through the slicing device and finally into the packaging device.

In a preferred embodiment of the invention, the press comprises a press chamber in which the products are pressed by movable dies. Here, the scanning chamber has an adjustable degree of opening for receiving products of different sizes. For receiving a large product, the pressing chamber is opened relatively wide and for receiving a small product, the scanning chamber is opened relatively little. Further, the first analyzing device is preferably a scanner (e.g. optical scanner, X-ray scanner) which determines the size of the incoming products. Therefore, the first analysis parameters provided by the scanner reflect the size of the incoming products. The control unit then adjusts the opening degree of the pressing chamber according to the size of the product to be pressed. On the hand, an unnecessary wide opening of the pressing chamber is avoided in this way. This allows a reduction of the cycle time, i.e. the number of products pressed per time unit. On the other hand, the adjustment of the opening degree makes sure that products of different sizes can be pressed in the pressing chamber.

In addition to the food processing apparatus according to the invention described above, the invention also claims protection for a corresponding food processing method. The individual process steps of the food processing method according to the invention already result from the above description, so that a separate description of the individual steps can be dispensed with at this point.

Other beneficial further modifications of the invention are indicated in the dependent claims or explained in more detail below together with the description of the preferred embodiment of the invention on the basis of the figures. They show:

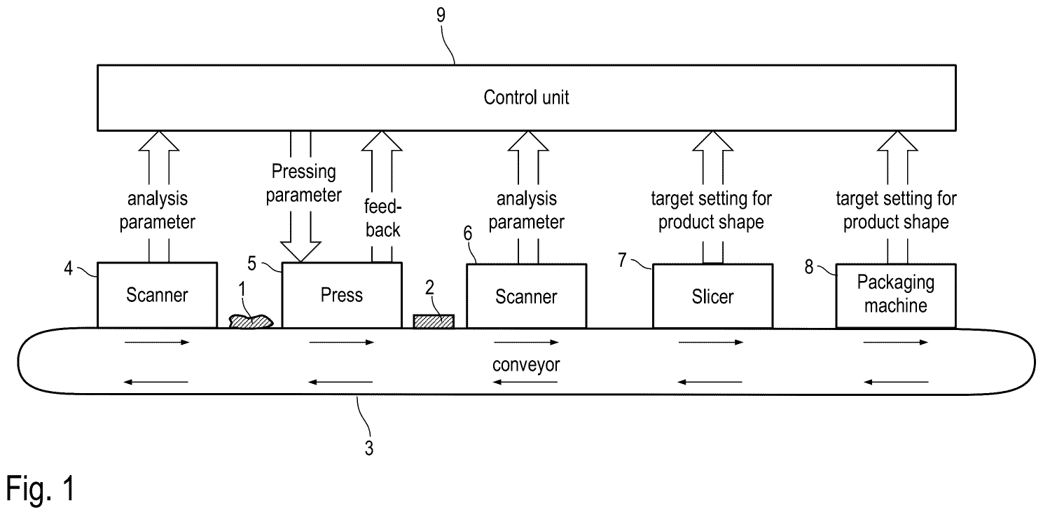

FIG. 1 shows a schematic representation of a food processing apparatus according to the invention,

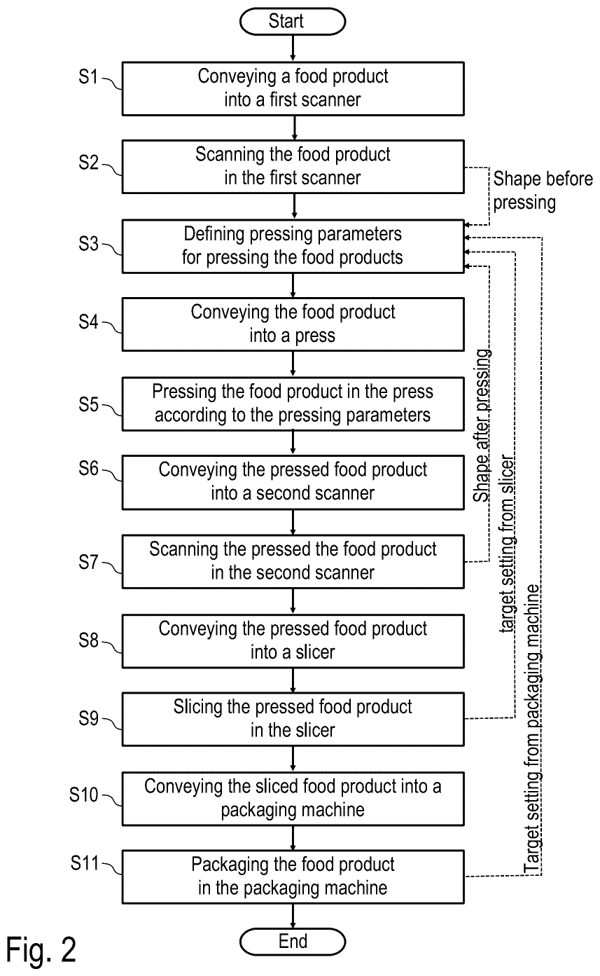

FIG. 2 shows a flow chart to illustrate the food processing method according to the invention,

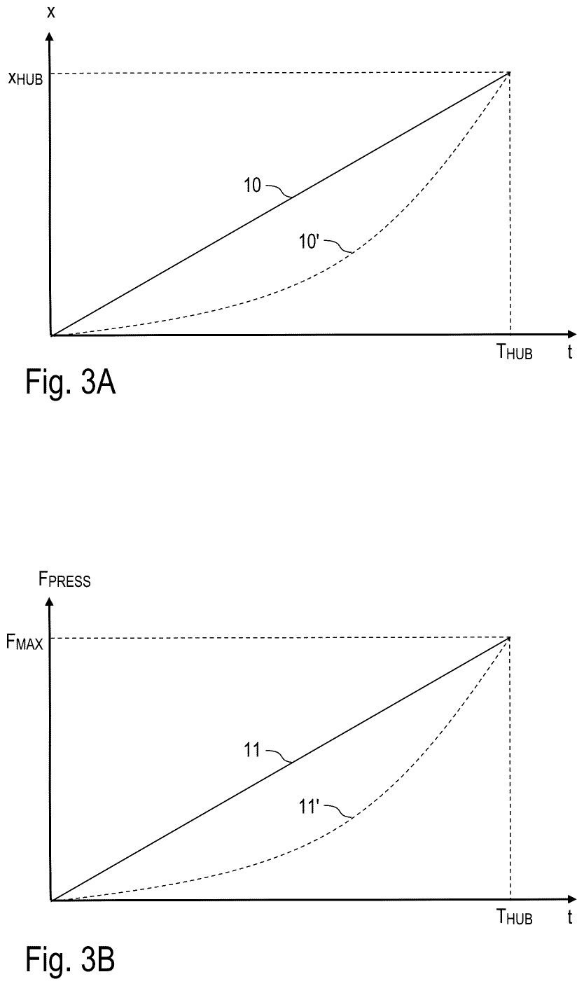

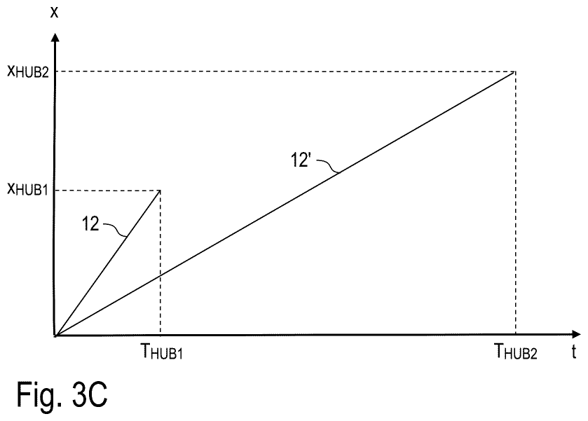

FIG. 3A shows different pressing travel-time curves,

FIG. 3B shows various pressing force-time curves,

FIG. 3C shows different pressing travel-time curves for different degrees of deformation,

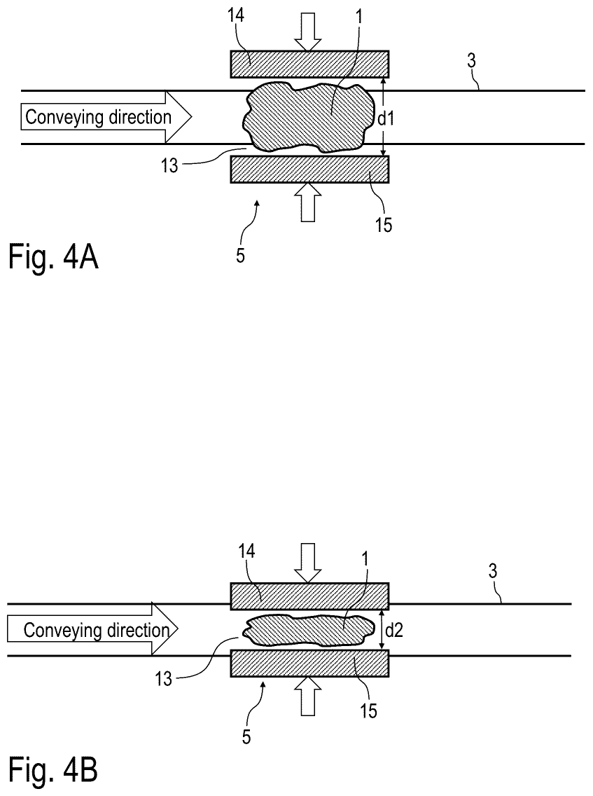

FIG. 4A schematically shows the pressing of a relatively large product, so that the pressing chamber is opened relatively wide, and

FIG. 4B schematically shows the pressing of a relatively small product, so that the pressing chamber is opened relatively little.

FIG. 1 shows a schematic representation of a food processing apparatus according to the invention for pressing, cutting and packaging food products, where a food product 1 is shown before pressing and a food product 2 is shown after pressing.

The food products 1, 2 are conveyed by a conveyor 3 in the direction of the arrow through the food processing apparatus, first through an optical scanner 4, through a press 5, through another optical scanner 6, through a slicing device 7 (“slicer”) and finally into a packaging machine 8, which packs the pressed and sliced food products 2 in trays. For this purpose, the packaging machine 8 can, for example, be designed as a thermoformer.

The optical scanner 4 optically scans the unpressed food products 1 before pressing and thus determines, for example, length, width, height, volume, shape, fat content, bone content, lean meat content and bone volume of the unpressed food products 1. The scanner 4 then outputs the corresponding analysis parameters to a control unit 9, whereby the control unit 9 controls the press 5 with the corresponding pressing parameters, as described in detail below. For example, the control unit 9 controls the degree of opening of the press 5, which will be explained later in detail with reference to FIGS. 4A and 4B.

The scanner 6 optically scans the pressed food products 2 after pressing and also transmits corresponding analysis parameters to the control unit so that the control unit 9 can adjust the pressing parameters accordingly, as described in detail below.

The slicing device 7 then cuts the pressed food products 2 into slices and forwards the sliced stacks to the downstream packaging machine 8, which then packs the sliced food products 2.

It should be noted that both the slicing device 7 and the packaging machine 8 pass on targets for the optimum product shape to the control unit 9. Packaging in trays with a certain tray size usually requires a certain product shape that is optimally suited.

In addition, the slicing device 7 also has a preferred product shape, which is passed on to the control unit 9 so that the control unit 9 can optimize the pressing parameters accordingly.

In the following, the flow diagram shown in FIG. 2 is used to describe the food processing method according to the invention that can be carried out by the food processing apparatus as shown in FIG. 1.

In a first step S1, the conveyor 3 feeds the unpressed food products 1 into the scanner 4.

In the scanner 4, the unpressed food products 1 are then scanned in a step S2, generating corresponding analysis parameters.

In a step S3, pressing parameters are determined that are to be used to press the food product 1.

On the one hand, the analysis parameters previously determined by the scanner 4 are taken into account. This includes, for example, the product shape of the food products 1 before pressing. The pressing parameters also include the required degree of opening of the pressing chamber 13 of the press 5. For receiving a large product, the pressing chamber 13 is opened relatively wide and for receiving a small product, the scanning chamber 13 is opened relatively little.

On the other hand, when determining the pressing parameters in step S3, the shape of the food products 2 after pressing is also taken into account, whereby this product shape is determined in step S7 by the second scanner 6.

In addition, when determining the pressing parameters in step S3, the targets set by the slicing device 7 and the packaging machine 8 are also taken into account.

In a step S4, the food product 1 is then conveyed into the press 5.

In a step S5, the food product 1 is then pressed in the press 5 with the specified pressing parameters.

During the pressing process, the control unit 9 receives a feedback from the press 5, which enables the control unit 9 to evaluate the pressing process. For example, the press 5 reports actual values of the pressing force and the pressing travel to the control unit 9. The control unit can then calculate the product strength, which also reflects the degree of freezing of the pressed food product 1. This is advantageous because the pressing process is irreversible only at low product temperatures in the freezing range. When pressing warmer products, on the other hand, the product deformation largely recedes after pressing, which is undesirable. It therefore makes sense for the control unit 9 to generate an error message if the evaluation of the feedback from the press 5 shows that the food products 1 are too warm for a proper pressing process.

The pressed food product 2 is then conveyed from the press 5 to the scanner 6 by the conveyor 3 in a step S5.

In a step S7, the pressed food product is then scanned in the second scanner 6, determining appropriate analysis parameters, which are then forwarded to the control unit 9.

In a step S8, the pressed food product 2 is then conveyed from the scanner 6 to the slicing device 7.

In a step S9 the pressed food product 2 is then cut into slices in the slicing device 7.

In the next step S10, the sliced food product 2 is then conveyed to the packaging machine 8 and finally packaged in a final step S11.

The pressing parameters specified by the control unit 9 can also include a pressing travel-time curve of 10 or 10′, as shown in FIG. 3A. In the case of pressing travel-time curve 10, the pressing travel x increases linearly with time until the maximum pressing travel x_{HUB} is finally reached after the specified press duration T_{HUB}. The pressing travel x is the compression travel covered by the food product 1 during deformation.

In contrast, the pressing travel-time curve 10′ differs from the pressing travel-time curve 10 by a progressive course, which can lead to an optimization of the pressing process.

The pressing parameters specified by the control unit 9 may also include a pressing force-time curve 11 or 11′, as shown in FIG. 3B.

With the pressing force-time curve 11, the pressing force F_{PRESS} increases linearly with the time t during the T_{HUB} press duration.

The pressing force-time curve 11′, on the other hand, has a progressive curve, which can contribute to an optimization of the pressing process.

FIG. 3C finally shows two pressing travel-time curves 12, 12′.

With the pressing travel-time curve 12, the pressing process takes place within a short pressing time T_{HUB1} with a relatively small pressing travel X_{HUB1}. This means that the degree of deformation is relatively low, so that pressing can be carried out relatively quickly without any risk of damage to the food product.

With the pressing travel-time curve 12′, on the other hand, the degree of deformation is much greater, so that it is advantageous to press more slowly, i.e. with a much longer T_{HUB2} press duration.

FIGS. 4A and 4B illustrate the pressing of products 1 of different sizes in the press 5 which comprises a pressing chamber 13 with an adjustable degree of opening d1, d2 and movable dies 14, 15 for pressing the product 1.

In FIG. 4A on the one hand, the product 1 to be pressed is relatively large. The size of the product 1 is determined by the scanner 6 and the control unit 9 controls the press 5 so that the pressing chamber 13 opens relatively wide for receiving the large product 1, i.e. the degree of opening d1 is relatively large.

In FIG. 4B on the other hand, the product 1 to be pressed is relatively small. The size of the product 1 is determined by the scanner 6 and the control unit 9 controls the press 5 so that the pressing chamber 13 opens relatively little for receiving the small product 1, i.e. the degree of opening d2 is relatively small.

Therefore, an unnecessary wide opening of the pressing chamber 13 is avoided and the press 5 is nevertheless suitable to receive products 1 of different sizes.

The invention is not limited to the preferred embodiment described above. Rather, the invention comprises various variants and modifications which also make use of the inventive idea and therefore fall within the scope of protection. In particular, the invention also claims protection for the subject-matter and the features of the dependent claims independently of the claims referred to in each case and in particular also without the features of the main claim. The invention thus comprises various invention aspects which enjoy protection independently of each other.

### LIST OF REFERENCE SIGNS

1 Food product before pressing
2 Food product after pressing
3 Conveyor
4 Scanner before the press
5 Press
6 Scanner behind the press
7 Slicing device
8 Packaging machine
9 Control unit
10, 10′ Pressing travel-time curve
11, 11′ Pressing force-time curve
12, 12′ Pressing travel-time curve
13 Pressing chamber
14, 15 Dies of the press
d1, d2 Degree of opening of the pressing chamber
x Pressing travel
X_{HUB} Pressing travel
T_{HUB} pressing time
F_{MAX} Maximum pressing force
t Pressing time

1. A food processing apparatus for processing food products, comprising:
a press configured to press the food products according to specific pressing parameters;
a first analyzing device configured to analyze the food products before pressing and configured to generate corresponding first analysis parameters of the food products, the first analysis parameters representing product properties of the food product; and
a control unit connected to the press on an output side and which is configured to set the pressing parameters of the press and is connected on an input side to the first analyzing device and configured to receive the first analysis parameters and to set the pressing parameters of the press as a function of the first analysis parameters.

2. The food processing apparatus of claim 1, wherein the first analyzing device is an optical scanner.

3. The food processing apparatus of claim 1, wherein the control unit is configured to set at least one of the following pressing parameters:
maximum pressing force in at least one pressing axis,
press stroke in at least one press axis which are aligned transversely to each other,
pressing time,
pressing force-time characteristic curve which represents a course of the pressing force as a function of pressing time in at least one pressing axis,
pressing path-time characteristic curve, which represents the course of a pressing path as a function of the pressing time in at least one pressing axis,
overall behavior model of the at least one press axis, and
massage parameters for massaging the food products during pressing.

4. The food processing apparatus of claim 3, wherein the first analyzing device is an optical scanner.

5. The food processing apparatus of claim 3, wherein
the control unit is configured to determine an actual shape of the food products before pressing from the first analysis parameters,
the control unit is configured to use the determined actual shape of the food products before pressing and a predetermined desired target shape to determine a required degree of deformation which is necessary to press the food product from the actual shape into the target shape, and
the control unit is configured to set at least one pressing parameter as a function of the required degree of deformation, so that the food products with a high degree of deformation are deformed more gently than the food products with a low degree of deformation.

6. The food processing apparatus of claim 5, wherein the first analyzing device is an optical scanner.

7. The food processing apparatus of claim 5, wherein the at least one pressing parameter comprises a pressing duration and/or a pressing speed.

8. The food processing apparatus of claim 1, further comprising
a second analyzing device configured to examine the food products after pressing and to generate corresponding second analysis parameters of the food products, wherein the second analysis parameters reflect product properties of the pressed food product; and
wherein the control unit is connected on the input side to the second analyzing device and is configured to receive the second analysis parameters to set the pressing parameters as a function of the second analysis parameters.

9. The food processing apparatus of claim 8, wherein the first analyzing device is an optical scanner.

10. The food processing apparatus of claim 8, wherein the second analyzing device comprises a temperature measuring device which is configured to measure the temperature of the food products as a product property.

11. The food processing apparatus of claim 10, wherein the first analyzing device is an optical scanner.

12. The food processing apparatus of claim 8, wherein the control unit is configured to use the second analysis parameters to analyze whether the pressed food product has been changed as desired or undesired by the previous pressing process, by a division of the food product, or
a bone fracture in the food product, or
a formation of a brow, or
a shaping of the product shape up to corners, or
form fidelity according to a form set used in the press, or
relaxation of the product after pressing, and
wherein the control unit adjusts the pressing parameters if the pressed food product has been altered in an undesirable form by the previous pressing process.

13. The food processing apparatus of claim 8, further comprising
a slicing device configured to slice the pressed food products after pressing; and/or
a packaging device configured to package the food products after pressing; and/or
a conveying device configured to convey the food products along a conveying path.

14. The food processing apparatus of claim 13, wherein the first analyzing device is an optical scanner.

15. The food processing apparatus of claim 13, wherein the conveying path is successively through the first analyzing device, through the press, through the second analyzing device, through the slicing device and into the packaging device.

16. The food processing apparatus of claim 15, wherein the first analyzing device is an optical scanner.

17. The food processing apparatus of claim 13, wherein
the slicing device and/or the packaging device transmits nominal specifications for the food product properties to the control unit, and
the control unit sets the pressing parameters as a function of the nominal specifications.

18. The food processing apparatus of claim 17, wherein the first analyzing device is an optical scanner.

19. The food processing apparatus of claim 1, wherein the first analyzing device is configured to determine at least one of the following product properties:
length of the food product,
width of the food product,
amount of food product,
volume of the food product,
form of the food product,
fat content of the food product,
bone content of the food product,
lean meat content of the food product,
bone volume of the food product,
bone shape of the food product,
presence of a brow of the food product.

20. The food processing apparatus of claim 19, wherein the first analyzing device is an optical scanner.

21. The food processing apparatus of claim 1, wherein
the control unit is connected to the press on the input side and receives feedback from the press in the form of pressing parameters,
the control unit uses the pressing parameters reported back by the press to calculate a product strength variable which reflects the food product strength of the pressed product, wherein the product strength variable reflects a degree of freezing of the pressed product.

22. The food processing apparatus of claim 21, wherein the first analyzing device is an optical scanner.

23. The food processing apparatus of claim 1, further comprising
a slicing device configured to cut the pressed food products after pressing; and
a packaging device configured to package the food products after pressing and after slicing, and
wherein the slicing device and the packaging device transmit target specifications for the food product properties to the control unit, and
wherein the control unit sets the pressing parameters as a function of the target specifications.

24. The food processing apparatus of claim 23, wherein the first analyzing device is an optical scanner.

25. The food processing apparatus of claim 23, wherein the target specifications are a desired target shape of the food products.

26. The food processing apparatus of claim 25, wherein the first analyzing device is an optical scanner.

27. The food processing apparatus of claim 1, further comprising
a slicing device configured to cut the pressed food products after pressing; and
a packaging device configured to package the food products after pressing and after slicing, and
wherein the slicing device or the packaging device transmit target specifications for the food product properties to the control unit, and
wherein the control unit sets the pressing parameters as a function of the target specifications.

28. The food processing apparatus of claim 27, wherein the first analyzing device is an optical scanner.

29. The food processing apparatus of claim 27, wherein the target specifications are a desired target shape of the food products.

30. The food processing apparatus of claim 29, wherein the first analyzing device is an optical scanner.
